(19) United States
(12) Patent Application Publication
(10) Pub. No.: US 2023/0201849 A1
(43) Pub. Date: Jun. 29, 2023

(54) ELECTROSTATIC CENTRIFUGAL SPRAYER WITH PULSED OR CONTINUOUS DIRECT ELECTRIFICATION

(71) Applicants: Spraying Systems Co., Wheaton, CA (US); Embrapa, Brasília (BR)

(72) Inventors: Aldemir Chaim, Jaguariuna (BR); Edson Francelino Ribeiro da Rocha, Sao Caetano do Sul (BR)

(73) Assignees: Spraying Systems Co., Wheaton, IL (US); Embrapa, Brasília (BR)

(21) Appl. No.: 17/384,063

(22) PCT Filed: Jan. 24, 2020
(86) PCT No.: PCT/US2020/015039

§ 371 Date: Jul. 23, 2021

Related U.S. Application Data
(60) Provisional application No. 62/796,857, filed on Jan. 25, 2019.

(51) Int. Cl. B05B 5/00; B05B 5/04; A01M 7/00

(52) U.S. Cl. CPC B05B 5/007; B05B 5/0407; B05B 5/0415; A01M 7/0028

(57) ABSTRACT

An electrostatic centrifugal spraying system for direct electrification includes a tank configured to store liquid. The tank includes an internal dielectric surface and an external conducting surface, wherein when the liquid is stored in the tank, the tank is configured to act as a capacitor storing electrical energy for electrostatic spraying. The spraying system further includes a power supply, configured to electrify liquid drops of the stored liquid, and a spray nozzle, comprising a spray disk for blowing the electrified liquid drops unto a target.

### CROSS-REFERENCE TO RELATED APPLICATIONS

This patent application claims the benefit of the U.S. Provisional Patent Application No. 62/796,857, filed Jan. 25, 2019, and PCT International Patent Application No. PCT/US2020/015039, filed Jan. 24, 2020, which are incorporated by reference.

### BACKGROUND

Formation of droplets in commercial spray devices occurs due to a difference in displacement velocity between two fluids. One of the fluids is usually air and the other is a spray liquid. To produce drops or droplets, either the spray liquid is accelerated, causing it to collide with relatively still air, or the air is accelerated, causing it to collide with the relatively still spray liquid. In both cases, to improve efficiency of droplet production, it is desirable to form the spray liquid into a film before it is converted into droplets. In particular, this pre-filming of the spray liquid can obtain more uniform droplets.

Spray nozzles using rotary disks for forming a film of the liquid produce the most homogeneous droplets among industrial spray devices. In relation to the hydraulic nozzles traditionally employed in agriculture applications, rotary or centrifugal spray nozzles advantageously allow a large variation in droplet size from a fixed liquid flow. The size of the droplets can be controlled by the rotation of the rotary disk, and thus many types of pesticides can be sprayed with the same spray nozzle. Centrifugal nozzles can also spray highly viscous liquids, which make them important in applying aqueous solutions of adjuvants, for inhibiting the evaporation of droplets or oily products. Although rotating nozzles have advantages in terms of the quality of droplets and the versatility of liquids they can spray, they are not widely used for agriculture. A reason for this may be that centrifugal nozzles throw liquid droplets perpendicular to the rotary disk, and the droplets fall by gravity onto the plants. Thus, the droplets cannot penetrate plant canopies because they end up accumulating on the outermost leaves.

Applying pesticides in agriculture applications can be complex compared to spraying liquid in an industrial setting. When applying pesticides, multiple targets of differing proportions are involved, and environmental conditions are usually uncontrollable. Using droplets of fluid with electrostatic charge is promising for achieving increased deposition of the fluid (e.g., pesticides) on plants. When a cloud of charged droplets approaches a plant, an induction phenomenon occurs, and the vegetal surface of the plant acquires a charge opposite to that of the charged droplets. Consequently, the plant strongly attracts the charged droplets, promoting pesticide deposition on the vegetal surface, as well as on the inferior surface of leaves of the plant. In addition to being attracted by the charged surface of the plants, the droplets with electrostatic charge are also guided by mutual repulsion between droplets with the same polarity. Mutual repulsion of pesticide droplets improves the distribution of the pesticide on the plants. In agricultural applications, electrostatic attraction is inversely related to droplet size. The effect is most intense for droplets with diameters less than 100 micrometers.

The use of electrostatics for applying pesticides can significantly reduce required active ingredients in phytosanitary treatments without reducing biological efficacy. In addition to improving pest and disease control efficiency, electrostatic spraying reduces side effects of pesticides on organisms living in the soil, since soil losses can be significantly lower compared to soil losses in conventional spraying.

Spray droplets can be electrified using several different processes. These include a direct charging electrification system in which the liquid is connected to a high voltage source and the droplets acquire charge and are attracted by induction to grounded bodies near the nozzle. An indirect induction charging system can also be used. In an indirect induction charging system the liquid is grounded and the electrification of the droplet occurs by induction at the time of its formation due to a high voltage electrode held near the droplet forming zone can also be used. Another process that can be used is a corona charge system where a pointed electrode ionizes the air near the droplets, and the droplets are charged when they collide with the ionized air molecules.

Each of these processes has significant disadvantages. Electrification of centrifugal nozzle droplets when using conductive liquids, such as aqueous solutions, is problematic for corona charge systems and for induction charge systems with or without grounding of the liquid. In a corona charge system, e.g., in Weinstein et al., U.S. Pat. No. 5,039,019, which is hereby incorporated herein by reference in its entirety, the use of extremely high voltages between 60,000 V and 100,000 V is required. In indirect induction electrification systems where the liquid is kept grounded, droplets acquire opposite signal charge of the induction electrode and are attracted towards it, causing intense wetting throughout the spraying device. These indirect electrification systems can lose efficiency quickly due to liquid droplets becoming attracted to an electrode of the voltage supply and eventually causing the voltage supply to short circuit. Electrostatic spraying systems that use direct electrification of the liquid have some advantages compared to indirect electrification systems. However, direct electrostatic conductive liquid can present serious insulation problems. Direct electrification systems also utilize very high voltages for electric field formation between the liquid being sprayed and the target to be reached by the droplets.

### SUMMARY

An embodiment of the disclosure provides an electrostatic centrifugal spraying system for direct electrification comprising: (a) a tank configured to store liquid, the tank comprising an internal dielectric surface and an external conducting surface, wherein when the liquid is stored in the tank, the tank is configured to act as a capacitor storing electrical energy for electrostatic spraying; (b) a power supply configured to electrify liquid drops of the stored liquid; and (c) a spray nozzle comprising a spray disk for blowing the electrified liquid drops unto a target.

An embodiment of the disclosure provides a spray nozzle for use in an electrostatic centrifugal spraying system. The spray nozzle comprises: a liquid inlet for receiving charged spray liquid; a motor; and a spray disk coupled to the motor, the spray disk configured to blow electrified liquid drops of the charged spray liquid unto a target via a rotation provided by the motor.

### BRIEF DESCRIPTION OF THE DRAWINGS

FIG. 1 is a schematic diagram of an electrostatic centrifugal spray system according to an embodiment of the disclosure;

FIG. 2 is a schematic side sectional view of an electrostatic centrifugal spray nozzle according to an embodiment of the disclosure.

FIG. 3 is another schematic side sectional view of the electrostatic centrifugal spray nozzle of FIG. 2.

FIG. 4 is side sectional view of a fastening bracket for the centrifugal spray nozzle of FIGS. 2 and 3.

FIG. 5 is an end view of the fastening bracket of FIG. 4 showing the holding flaps of the motor and high voltage insulation shaft.

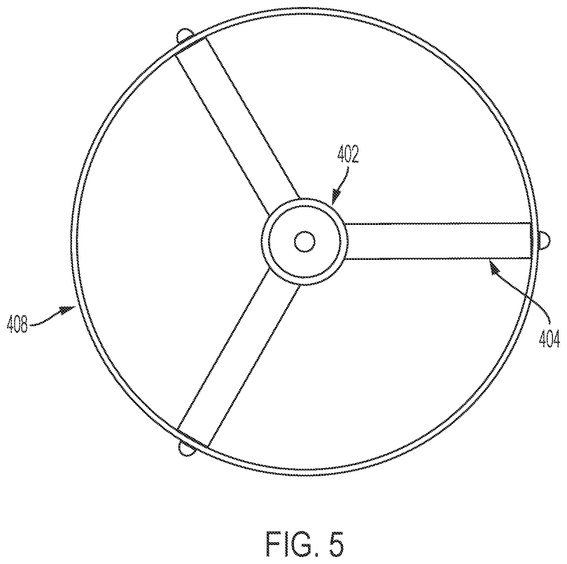

FIG. 6 is a partial side sectional view of the spray propeller cup of the centrifugal spray nozzle of FIG. 2.

FIG. 7 is an end view (viewed in the direction a of FIG. 6) of the spray propeller cup of FIG. 6.

FIG. 8 is the opposing end view (viewed in the direction (3 of FIG. 6) of the spray propeller cup of FIG. 6.

FIG. 9 is a schematic side sectional view of an alternative embodiment of a cententrifugal spray nozzle according to the disclosure that includes one motor for the spray cup and another motor for forced ventilation.

FIG. 9 is a diagram of a capacitive discharge high-voltage electronic circuit for electrification of the sprayed liquid according to an embodiment of the disclosure.

### DETAILED DESCRIPTION

The disclosure provides an electrostatic centrifugal spray system utilizing direct electrification. The disclosed spray system can be used in industrial or agricultural applications. In a direct electrification system, droplets acquire high charge intensities, which in some cases may be close to the known Rayleigh limit, expressed by Eqn. 1:

q_{R}=π×(8×ε₀×γ×D³)^{1/2} Eqn 1

where q_{R} is the maximum charge a drop can acquire without disintegration, ε₀ is vacuum permittivity, γ is the liquid surface tension, and D is the drop's diameter. Droplets that reach electric loads above the Rayleigh limit go through electromechanical instabilities and disintegrate into smaller droplets. Lack of knowledge concerning voltage, amperage and liquid flow parameters for acceptable operation of direct electrification systems for hydraulic, pneumatic and centrifugal nozzles has rendered direct electrification technique virtually unusable in an equipment with electrically conductive spray mixture.

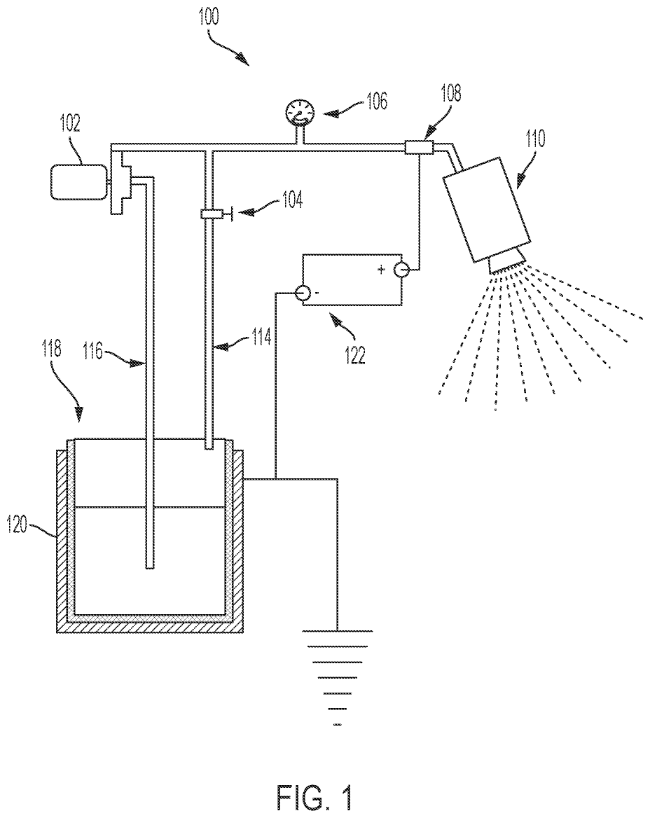

FIG. 1 illustrates an electrostatic centrifugal spraying system 100 that uses the direct electrification technique. The spraying system 100 includes: a centrifugal pump 102, a pressure regulation valve 104, a pressure gauge 106, a spraying liquid electrification point 108, a spray nozzle 110, an overflow return pipe 114, a suction pipe 116, a liquid storage tank 118 with a dielectric plastic inner wall, an external surface 120 to the tank, and a high voltage power supply 122 with pulsed or continuous current. The external surface 120 can be a conductive metal, grounded, to convert the liquid storage tank 118 into a capacitor for electrical energy storage for electrostatic spraying. The dielectric plastic wall can be polypropylene.

In an embodiment, the capacitive discharge high voltage power supply 122 triggers direct current (DC) pulses from 1 to 60 kV to the spraying liquid electrification point 108. These DC pulses move through the liquid, both to the spray nozzle 110 and to the liquid storage tank 118 of the spraying system 100. The liquid storage tank 118 can be made of dielectric material on the inside and with a conductive external surface 120, so that the liquid inside the liquid storage tank 118 functions as one electrode of a capacitor, and the grounded conductive external surface 120 functions as the other electrode. The capacitor is a Leyden bottle, and electrical energy storage capacity of this kind of Leyden bottle depends on the pulse voltage and pulse frequency supplied by the high voltage power supply 122 and on the wall thickness of the liquid storage tank 118 and the external surface 120.

The low power associated with spraying in direct electrification facilitates adopting measures for insulating the liquid storage tank 118, the suction pipe 116, the return pipe 114, and the centrifugal pump 102 of the sprayer. Insulation can be obtained with some types of plastics, such as polypropylene or polyethylene having resistivity greater than 10¹⁷ ohm·cm, dielectric strength around 100 to 110 kV/mm, dielectric constant around 2.2 to 2.3, and loss factor of 0.0002. The liquid storage tank 118, for example, may be made of stainless steel or brass, with an inner layer coated with 3 to 4 mm of polyethylene or polypropylene. It may also be made entirely of plastic covered with a thin metal film or painted with conductive ink.

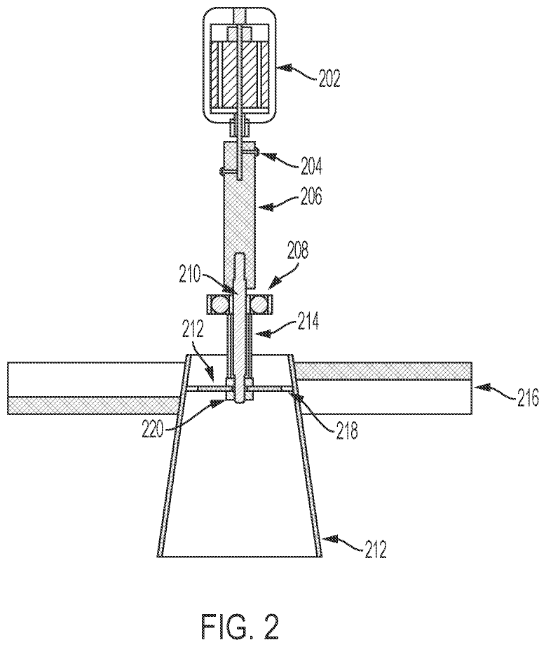

FIG. 2 provides a cross-sectional view of the electrostatic centrifugal spray nozzle 110 that can be used with the spraying system 100. The spray nozzle 110 includes a motor 202 coupled to a dielectric shaft 206 made from dielectric material for high voltage insulation. The motor 202 can be coupled to the dielectric shaft 206 via fastening by screws 204, with the dielectric shaft 206 transferring the rotation of the motor 202 to a metal shaft 210, which rotates under the action of a bearing 208. The metal shaft 210 is attached to a spray disk 212 via nuts 220 and a spacer 214, which rests on the bearing 208. The spray disk 212 can have propellers 216, and the spray disk 212 has a conical conformation with a flat internal section where the metal shaft 210 is fixed. The flat inner section has radially arranged holes 218 next to the inner wall of the spray disk 212 to allow internal flow and distribution of spray liquid.

The centrifugal pump 102 of FIG. 1, which can be driven by an electric motor or by an internal combustion engine, pressurizes the spray liquid into the spray nozzle 110. The pressure regulation valve 104 regulates the pressure of the liquid which can be monitored by the pressure gauge 106. The pumped liquid may have flow controlled by restrictor disks (not shown) until it reaches the internal flat section of the spray disk 212 where by centrifugal force is drawn into the distribution holes 218, spreading uniformly through the inner wall of the spray disk 212. The motor 202 rotates the spray disk 212 via the insulating shaft 206 and subsequently the metal shaft 210. The bearing 208 is provided for stabilization and vibration control purposes of the rotation because the distance between the motor 202 and the spray disk 212 is relatively large. The spray disk 212 is provided with propellers 216 which take advantage of the rotation and provide air flow at a speed sufficient to blow the droplets produced to the target.

The length of the dielectric shaft 206 may be determined by the breaking point of air dielectric rigidity to help prevent arcing from the voltage input to the motor 202. The dielectric rigidity (Eₘₐₓ) of the air is 3 kV/mm. Equation 2 defines the dielectric shaft length (L):

$$L = \frac{V}{{E}_{max}} \qquad Eqn 2$$

The value of dielectric rigidity can vary according to air variables, such as, humidity that enhances air's conductivity. Therefore, once the spray nozzle 110 starts producing small droplets in the air, dielectric rigidity will decrease. Thus, in some embodiments, a safety coefficient (SC) is included in the design for L, as shown in Equation 3 below. An example value for SC is 3.

$$L = \frac{V}{{E}_{max}} * S C \qquad Eqn 3$$

As an example, when applying 40 kV on the spray nozzle 110 using Equation 3, the result would be a dielectric shaft of 40 mm length. The diameter of the dielectric shaft 206 may be selected based on mechanical considerations. These include forces that the spray disk 212 being used applies to the dielectric shaft 206, rotation on the torque of the motor 202, and so on. Mechanical considerations can vary according to the motor or spray disk being used.

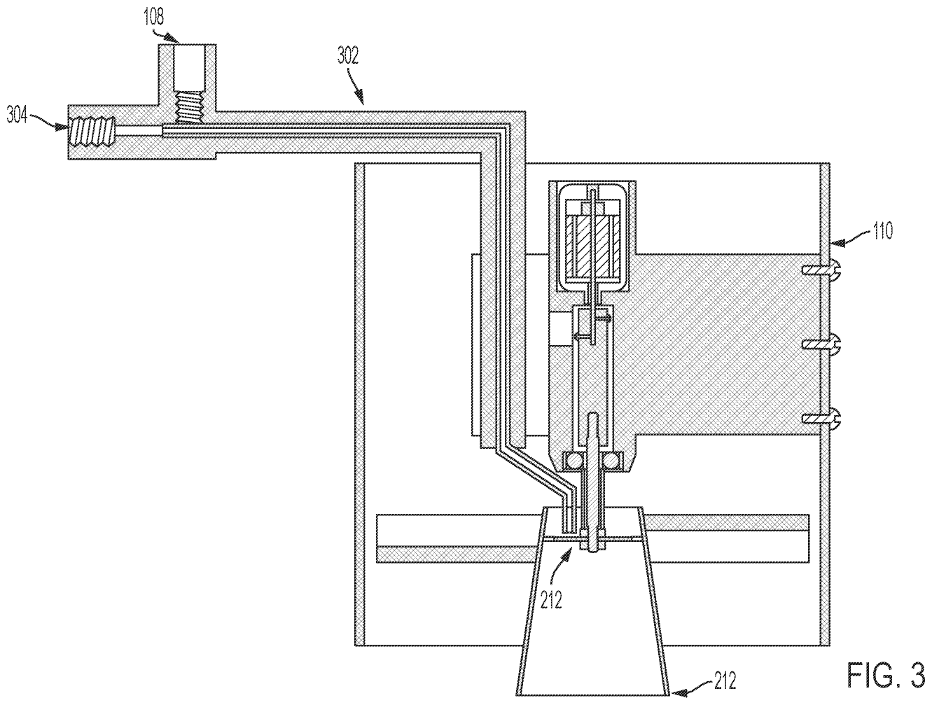

FIG. 3 provides a cross-sectional view of a spray nozzle, e.g., the spray nozzle 110. A liquid feed system including a liquid feed metal tube 302 feeds spray liquid to the internal flat section of the spray disk 212. The feed tube 302 contains a threaded inlet for a liquid feed 304 and a point of electrification of the spray liquid 108.

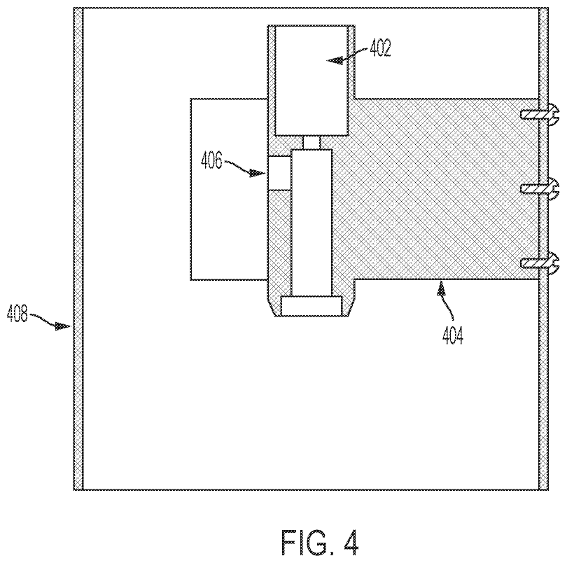

A fastening bracket of the centrifugal spray nozzle 110 is shown in FIG. 4. The spray nozzle 110 includes an engine mounting bracket 402 and an inspection hole 406 allowing access to the screws 204 which attach the motor 202 to the dielectric shaft 206 for high voltage insulation. The fastening bracket includes three centering flaps or fins 404 of, which also attach to an air flow concentration tube 408. The motor assembly with the dielectric shaft 206, the metal shaft 210, and the spray disk 212 is fixed in a structure consisting of the air flow concentration tube 408, where the engine mounting bracket 402 is attached to the three fins 404. The central body of the motor support 402 has the inspection hole 406 for screwing the motor to the dielectric shaft 206. As shown in FIG. 4, equidistant distribution of the three fins 404 allows for centering of the engine mounting bracket 402 driving the spray disk 212.

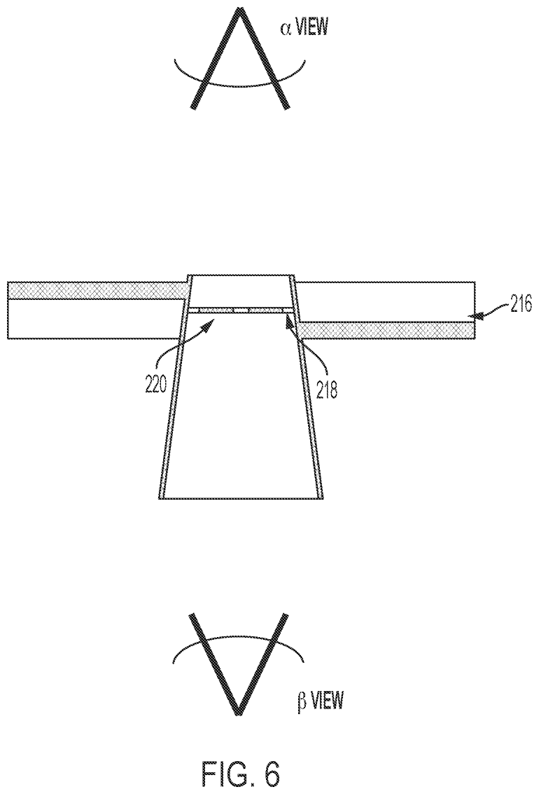

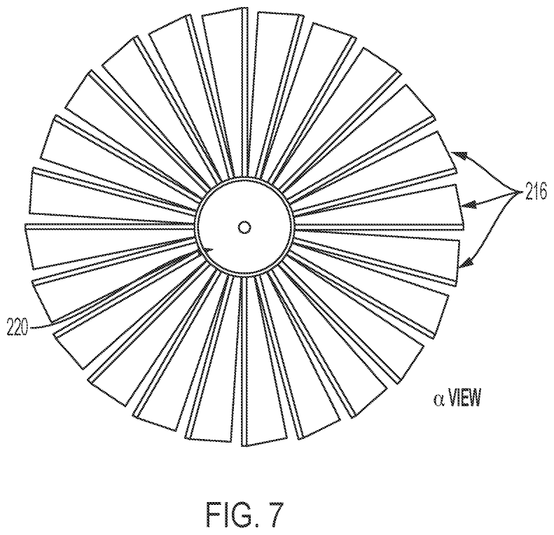

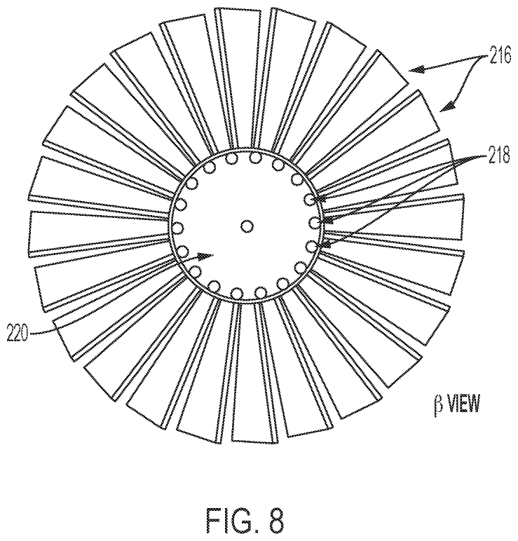

FIG. 6 illustrates a section of the spray disk 212 with propeller 216. FIGS. 7 and 8 illustrate front and rear views, respectively, of the spray disk 212 where the internal flat section 220 and radially arranged holes 218 are seen close to the inner wall of the spray disk 212.

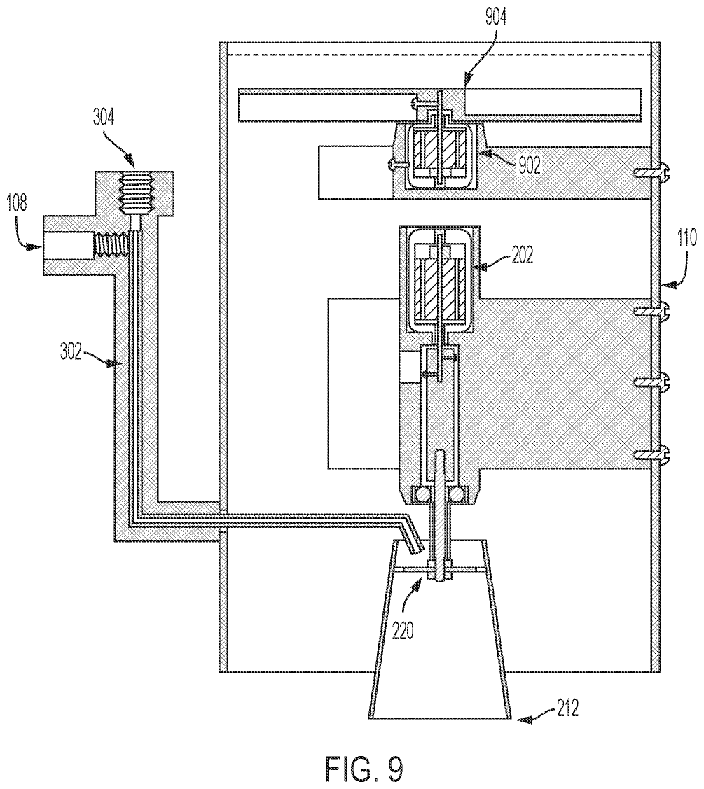

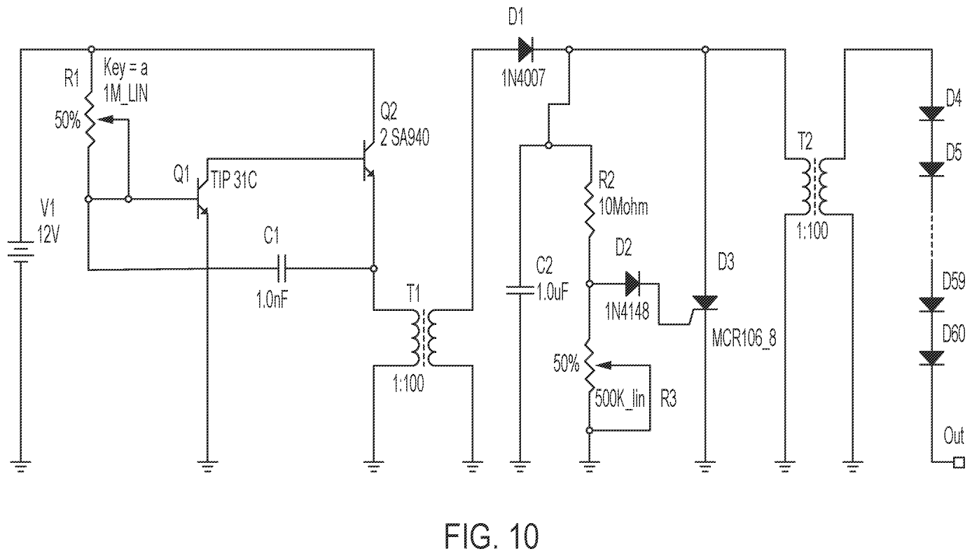

FIG. 9 illustrates an alternative embodiment of a spray nozzle featuring a propeller or a blower fan 904 and a spray disk driven by separate motors (items 902 and 202, respectively). The spray nozzle in FIG. 9 can be used in hand-held equipment where electrical energy source is critical. The blower fan 904 is driven by a separate motor 902, different than the motor 202 driving the spray disk 212. An advantage of the spray nozzle design of FIG. 9 is the ability to decouple droplet size produced (via the spray disk 212) and wind speed (via the blower fan 904) for blowing the droplets from the spray nozzle.

FIG. 10 illustrates an electronic capacitor discharge circuit for generating high voltage rectified pulses, according to an embodiment of the disclosure. FIG. 10 presents a proposal for an electronic schematic of a capacitive discharge high voltage power supply with two oscillator sub-circuits. The first sub-circuit includes an oscillator composed by an NPN transistor TIP 31 C and a PNP transistor 2SA940, which excite the primary winding of a transformer T1 at the oscillation frequency controlled by capacitor C1 and resistor R1. The secondary winding of the transformer T1, which has a relation of 1:100 turns with the primary, high voltage peaks arise between 500 and 600 Volts which are then rectified by diode D1 and stored in C2.

The second sub-circuit is a relaxation oscillator, consisting of a Silicon Controlled Rectifier (SCR) MCR106-8, with trigger control regulated by resistors R2 and R3 and with voltage accumulated in capacitor C2. Resistor R3 helps to avoid erratic trips due to a leakage current, once the voltage between anode and cathode is very high. As voltage builds up in capacitor C2, it flows through resistor R2 to trip the SCR MCR106-8 gate when it reaches 1.0 V. Diode D3 is a protection against negative polarity peaks that could damage the SCR component. When the SCR trip voltage is reached, it conducts and the high voltage stored in the capacitor, discharging the energy on the capacitor in the primary coil of the high voltage coil T2, which has a relation of 1:100 turns. Theoretically, if the primary coil receives pulses of 400 V, the secondary will provide up to 40 kV, which will be rectified by the serial association of the UF 4007 diodes. The frequency of the pulses of high voltage can be controlled by the variable resistor R1, which increases or decreases the voltage output from T1, or by changing the charge time of capacitor C2 through resistor R3.

Referring to FIG. 1, when the pulsed voltage is applied at the electrification point 108, the electricity travels through the liquid and charge accumulates in the liquid storage tank 118 which functions as a capacitor, in other words, a Leyden bottle. The capacitance of the tank volume does not change because, even if the liquid runs out, the liquid film present in the inner wall of the tank functions as the capacitor's armature. The amount of electrical energy stored in the tank will depend on the frequency and voltage of the pulses as well as the capacitance established by the area covered by the external surface 120 that is to be grounded. This grounding is beneficial not only to transform the tank into a capacitor but also to eliminate static charges that would be induced in the outer wall of the dielectric layer of the tank. It is observable that when a liquid stored in a plastic container is electrified, an electrostatic field is formed on its outer surface. Thus, a grounding of the outer surface can help avoid accidents.

When the liquid receives high voltage pulses at the electrification point 108, the energy travels through the metallic liquid feed tube 304, which conducts the liquid and the electricity to the internal flat section of the spray disk 212 where by centrifugal force action the electrified liquid is drawn into the distribution holes 218, spreading evenly through the inner wall of the spray disk 212. The electricity also distributes evenly over the surface of the liquid. When the liquid breaks into droplets on the rim of the glass, they carry the electric charges with them. The amount of charge carried by each drop depends on the flow rate of the liquid, the voltage applied to the system, the size of the droplets (which is influenced by the rotation of the spray disk 212), and the frequency of the pulses.

In high voltages pulses at low frequency, droplets with variable charges may be formed ranging from no charge buildup to a charge buildup near the Rayleigh limit. This is important for applying products to targets with complex morphology, because Faraday's cage effect causes the deposition to concentrate on the outside of the target. Thus, it is expected that, with wind blowing the droplets with different levels of charge, a more even distribution of drops occurs in regions of difficult access, such as inside the canopy of plants.

In an embodiment, to achieve electrification of droplets with pulsed electrification, the high voltage source 122 provides pulses of 1 to 60 kV, in a frequency of 1 to 60 hertz. The pulses are rectified by the association of 30 to 60 rectifier diodes of about 1 kV, which can be found at low cost. Electrification takes place directly in the liquid, and the spray disk 212 is articulated with the motor 202 with a dielectric shaft to avoid any possibility of discharge of high voltage in the motor's electric circuit.

Most power supplies of high-voltage direct current DC use Greinacher/Cockcroft-Walton cascade voltage multipliers through a combination of diodes and capacitors. For some time, high voltage diodes and capacitors were easily found in the market, since they were widely used in cathode ray tubes, which required these components to move or scan the electron beams to form the images, widely used in televisions. However, technological advances have modified TV screens and other devices for LCD (liquid crystal display) or LED (light-emitting diode) screens, which work with electronic components of relatively low voltages. Thus, due to lower demand, large companies that manufacture electronic components are ceasing manufacturing high-voltage electronic components.

Using embodiments of the disclosure, scarcity associated with high-voltage diodes and capacitors for building high-voltage DC sources does not have to affect a direct electrostatic sprayer. The direct electrostatic sprayer can use liquid storage tanks that function as a Leyden bottle, a primitive species of capacitor, that is, a device capable of storing electrical energy. For successful electrification of the droplets, the capacitive discharge high-voltage power supply should produce pulses of 1 to 60 kV, in the frequency of 1 to 60 hertz, which are rectified by a series association of 30 to 60 diodes of only 1 kV, easily found at low cost. In an embodiment, current pulses are sent directly to the liquid stored in the tank, which acts as one of the electrodes of a capacitor. The wall of the tank serves as the dielectric of the capacitor, and a network of metallic wires, or even strips of metal sheets bonded to the outer surface of the tank, serve as the other electrode of the capacitor, connected at the ground of the power supply and to the ground, by some conductor cable. In an embodiment, a centrifugal spray system is used since it provides better quality of droplet production with ease of changing droplet sizes without changing liquid flow.

In sum, according to one embodiment, the disclosed spray system generally includes a tank, composed of dielectric material, for the storage of aqueous or oily liquid. The tank is connected to hoses, discharge valves and ducts for conduction of liquid to a rotary or centrifugal spray nozzle. The tank supplies liquid to the spray nozzle. The spray nozzle includes a rotating spray disk, connected to an electrically insulated pumping system. A capacitive discharge high-voltage source may be used to electrify the liquid stored in the tank. The electrification of the liquid can be performed via voltage pulses rectified by diode association. The electrification of the liquid can also be performed by a continuous power source. In an embodiment, the inside of the tank is made of dielectric material, and the tank's external surface is metallized. Thus, allowing the tank to act as a capacitor that stores electric charge from rectified high voltage pulses. One of the electrodes of this capacitor is the liquid inside the tank, and the other electrode is the outer metalized surface, which can be grounded. For both pulsed and continuous electrification, the metallized and grounded external surface of the tank eliminates static charge build-up by reducing risk of unwanted electrical discharges.

An electrostatic sprayer according to embodiments of the disclosure provides several features, for example:
a. use of a voltage range between 1 kV to 60 kV so that the electrostatic sprayer provides an adequate level of liquid deposition on targets with complex morphology, e.g., plants;
b. use of high voltage with current ranging between 7 μA/mL to 10 μA/mL of liquid sprayed per second;
c. increased safety of the electrostatic sprayer due to low electrical power of the high voltage;
d. uses a direct liquid electrification technique and avoids the use of an induction electrode;
e. the ability to spray viscous liquids;
f. uses the liquid storage tank as a capacitor for the storage of high voltage pulses rectified by low voltage series diodes;

g. the ability to vary droplet sizes without varying liquid flow; and

h. creating droplets under low pressure; compared to conventional nozzles that require more energy to create higher pressures for obtaining smaller droplets, the spray disk according to embodiments of the disclosure is tasked with creating droplets from the liquid.

An electrostatic spraying system according to embodiments of the disclosure provides several advantages, for example:
a. The absence of induction electrodes external to the nozzle;
b. no wetting of the nozzle body;
c. high charge intensity on the drops coming from the sprayer;
d. reduced risks associated with high-voltage leakage;
e. a tank with an external grounded surface, a safety feature where liquid inside the tank induces charge on the outside of the tank so grounding the outside prevents sparks;
f. reduced risk of exposure of applicators to electric discharge;
g. reduced production costs associated with the high-voltage power supply;
h. reduced liquid consumption and increased operational capacity of the electrostatic spraying system;
i. increased spray transfer efficiency, that is, more of the liquid sprayed reaches the target compared to conventional sprayers (high liquid transfer to target surface occurs due to attraction acquired by the electrification of the droplets while conventional nozzles lose some of the liquid to the air, e.g., due to wind changes, conversion to vapor, etc.); and
j. reduced battery consumption from the high voltage power supply.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electrostatic centrifugal spraying system for direct electrification comprising:
a tank configured to store liquid, the tank comprising an internal dielectric surface and an external conducting surface, wherein when the liquid is stored in the tank, the tank is configured to act as a capacitor storing electrical energy for electrostatic spraying;
a power supply configured to electrify liquid drops of the stored liquid; and
a spray nozzle comprising a spray disk for blowing the electrified liquid drops unto a target.

2. The spraying system according to claim 1, wherein the power supply applies a pulsed voltage.

3. The spraying system according to claim 1, wherein the power supply applies a continuous voltage.

4. The spraying system according to claim 1, wherein the spray nozzle further comprises a propeller, the propeller aiding in blowing the electrified liquid drops unto the target.

5. The spraying system according to claim 4, wherein the spray nozzle further comprises a motor, and wherein the propeller is rotated via a rotation of the motor.

6. The spraying system according to claim 5, wherein the spray disk and the propeller are both rotated via the rotation of the motor.

7. The spraying system according to claim 4, wherein the spray nozzle further comprises a second motor, and wherein the spray disk is rotated via a rotation of the second motor.

8. The spraying system according to claim 1, wherein the external conducting surface of the tank is grounded.

9. The spraying system according to claim 2, wherein changing frequency and amplitude of the pulsed voltage affects electrification of the liquid drops.

10. A spray nozzle for use in an electrostatic centrifugal spraying system, the spray nozzle comprising:
a liquid inlet for receiving charged spray liquid;
a motor; and
a spray disk coupled to the motor, the spray disk configured to blow electrified liquid drops of the charged spray liquid unto a target via a rotation provided by the motor.

11. The spray nozzle according to claim 10, further comprising:
a dielectric shaft coupled to the motor; and
a metal shaft coupled to the dielectric shaft and the spray disk, wherein the rotation provided by the motor is transferred to the spray disk via the dielectric shaft and the metal shaft.

12. The spray nozzle according to claim 11, wherein the dielectric shaft is 40 mm.

13. The spray nozzle according to claim 11, further comprising:
a propeller configured to aid in blowing the electrified liquid drops unto the target.

14. The spray nozzle according to claim 13, wherein:
the propeller is coupled to the motor and is rotated via the rotation provided by the motor.

15. The spray nozzle according to claim 13, further comprising:
a second motor coupled to the propeller, the second motor configured to rotate the propeller.
